(19) United States
(12) Patent Application Publication
(10) Pub. No.: US 2010/0172483 A1
(43) Pub. Date: Jul. 8, 2010

(54) CONVERSATION OF A PHONE CALL INTO A SMART PUSHED VOICE MESSAGE

(75) Inventor: Moshe Weiner, Yehud (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: VIMPLICITY LTD., Or Yehuda (IL)

(21) Appl. No.: 12/278,971

(22) PCT Filed: Feb. 15, 2007
(86) PCT No.: PCT/IL07/00218

§ 371 Date: Aug. 10, 2008

Related U.S. Application Data
(60) Provisional application No. 60/774,630, filed on Feb. 21, 2006.

(51) Int. Cl. H04M 3/42

(52) U.S. Cl. 379/211.02

(57) ABSTRACT

A method and system for ensuring that a phone call from an initiating user reaches a target user, when the phone call is non-deliverable in real time. The phone call is converted at an instant voice messaging (IVM) server into an entity that can be delivered to the target user when the target user can receive it. The entity may be a parked call, a parked instant message, voice mail, an instant voice message, a multi media server message, a push-to-talk message or an ICQ message. Its delivery is performed according to predetermined or ad-hoe rules, decided either by the IVM server, the initiating user or the target user.

### FIELD OF THE INVENTION

The present invention relates to voice mail smart messaging and in particular to allowing a phone call to be completed even if a target user is not available or capable to receive it in real time.

### BACKGROUND OF THE INVENTION

Instant voice messaging (IVM) creation, push and retrieval are known, see for example U.S. Patent Application No. 2006/0268750 by Moshe Weiner, which is incorporated herein by reference. The invention described therein relates to a method and device for instant voice messages (IVM) to be instantly created, pushed and/or instantly retrieved even in cases in which target users do not have a conventional voice mail service. As described therein, if the target user does not answer an IVM server which received the message, the server may further process the message according to predetermined rules. The processing may include for example storage within the IVM server, transfer to a voice-mail system, or attempts to resend the message. Some possible rules mentioned therein include, by the IVM server, checking the presence status of each target user, be it a single user or a user belonging to a group, before setting up an IVM session with one or more target users. In case the presence status is “off-line”, an IVM session will not be set, and the voice message will be stored within the IVM server until the target end user becomes available.

Essentially, when a call cannot be completed, the solutions above suggest forwarding the call to a voice mail or converting the call into a parked call. However, the voice mail will be heard only when pulled by the target user, while a parked call will be pushed to the target user. It would be advantageous for a calling (initiating) user to have a mechanism that will enable him/her to leave a message that will be delivered (pushed) immediately when the target user becomes available. Further, it may be advantageous to both the initiating and target users that, if the target user is in a state of call waiting, the unanswered call will be turned into an instant voice message that may interrupt the flowing phone call for a limited time.

### SUMMARY OF THE INVENTION

The present invention provides a method and system that ensure that a phone call that is not deliverable to a target user in real-time (hereinafter referred to as “non-real-time-deliverable call”), is turned into an instant voice message that can be pushed to the target user either instantly (e.g. during a call waiting) or when the target user becomes available. A call may not be deliverable in real-time for various “non-delivery reasons”: the target user's phone may be “busy” and/or “call waiting”, “unavailable”, “turned off” or with an “off-line” presence status. In such a situation, the present invention suggests to forward the call to a “smart messaging server”, for example an IVM server. The smart messaging server will receive the call forwarded to it and will also receive the call target number. The call forwarding to the server may be performed by a telephony system or by a voice over Internet Protocol (VoIP) telephony system. The forwarded call will then be processed into an entity that will be delivered (pushed) to the target user in a certain way either immediately or when the target user becomes available.

According to the present invention there is provided, in a voice communications network, a method for ensuring that a phone call from an initiating user reaches a target user, comprising the steps of: by the initiating user, placing a phone call to the target user; if the phone call is non-real-time-deliverable because of a non-delivery reason, forwarding the phone call to an IVM server; at the IVM server, converting the phone call into a converted entity; and, by the IVM server, delivering or pushing the converted entity to the target user.

According to the present invention there is provided, in a communications network, a system for ensuring that a phone call from an initiating user reaches a target user comprising an IVM server operative to receive a non-real-time deliverable phone call, a management function operative to convert the received call into a converted entity and to deliver the converted entity to the target, and a switch coupled to the IVM server and operative to effect communications between the initiating user, the target user and the NM server.

According to the present invention there is provided, in a voice communications network, a method for ensuring that a phone call from an initiating user reaches a target user, comprising the steps of: by the initiating user, placing a phone call to the target user; if the call is not answered for non-delivery reasons, by a telephony system included in the communication system, forwarding the call to an enhanced NM server; at the IVM server, converting the phone call into a converted entity according to a rule selected from the group consisting of a pre-defined rule and an ad-hoc rule; and by the IVM server, delivering or pushing the converted entity to the target user.

### BRIEF DESCRIPTION OF THE DRAWINGS

The invention is herein described, by way of example only, with reference to the accompanying drawings, wherein:

FIG. 1 shows schematically a system for conversion of a phone call into a smart push voice message according to the present invention;

FIG. 2 shows a general flow chart of the major steps in the method for conversion of a phone call into a smart pushed voice message according to the present invention.

### DETAILED DESCRIPTION OF THE INVENTION

The present invention discloses a method and a device that can enable “smart call forwarding” of a non-real-time deliverable phone call to a smart messaging server (e.g. the IVM server disclosed in U.S. Patent Application No. 2006/0268750, enhanced in some embodiments with an added management function, see below) in cases in which a target user cannot receive the call in real time or when the call cannot be completed in real time for one of the non-delivery reasons mentioned above. The present invention enables target users to receive a message (exemplarily a voice message) instead of the telephone call even in cases in which they do not have a conventional voice mail service. The message will be “pushed” to the target user by predetermined rules, either immediately or when he/she becomes available.

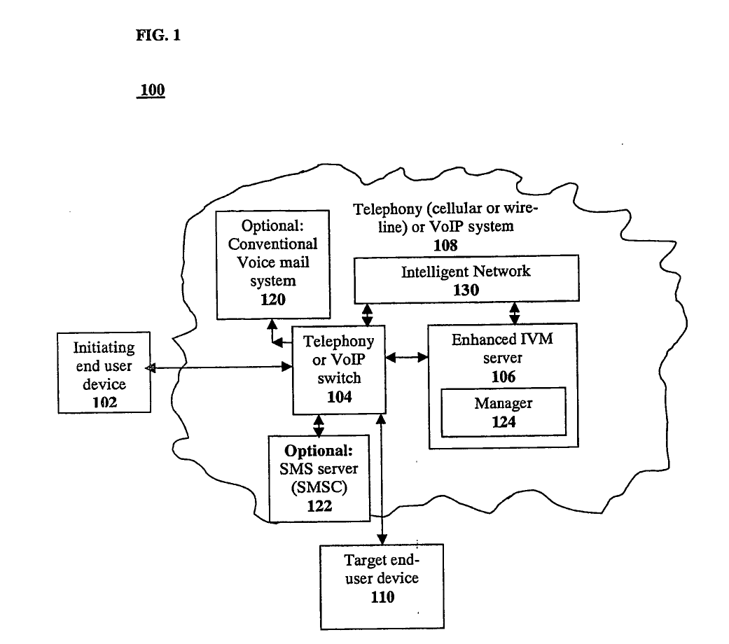

FIG. 1 shows schematically a system 100 for conversion of a non-real-time-deliverable phone call into a converted entity according to the present invention. The converted entity may be a parked call, parked instant voice message, voice mail, instant voice message, or into another type of message (multi media message (MMS), push-to-talk (PTT) message, ICQ message, etc). The converted entity is then delivered (pushed) to the target user either immediately or when he/she become available. The system includes at least one initiating end user device 102 in communication with a target device (handset) 110 through a telephony system 108. The telephony system includes a telephony or VoIP switch 104, an enhanced IVM server 106 and an optional Intelligent Network (IN) system 130, interconnected as shown. IN system 130 performs the smart call forwarding to the IVM server 106 (i.e. forwards to the IVM a call not answered in real time). The IN system is “optional” in the sense that its functions may, in some embodiments, be performed by other elements or functions of system 100. In general, IN system 130 can be considered a network that can among other things, perform smart call redirections and handle presence (availability of users to receive phone calls). A presence parameter can be any parameter that will indicate to IVM 106 and/or to telephony system 108 that the target user is not available to receive phone calls and/or instant messages. An exemplary presence parameter is described in detail in U.S. Patent Application No. 2006/0268750. In some embodiments, IN system 130 can be replaced by other reduction-to-practice components or systems. For example, call redirection can be performed by telephony switch 104, while presence can be detected by: a) sending a special SMS message usually called an “SMS 0” to the target user with a request of delivery (from the telephony system 108). This message can notify the IVM server that e.g. the target user is already available and isn't turned-off any more; b) sending a regular SMS with a delivery report request. The presence mechanism can be implemented within the IVM server as described in previous application, as described hereinabove, by calling the target user and sensing the dial-tone, or by “asking” an SMSC to send SMS messages with delivery reports.

The enhanced NM server includes all the functions of the IVM server in U.S. Application 2006/0268750 plus a management function or module 124. Management module 124 allows a target user to set up pre-defined rules for call completion. Module 124 also enables the target user to decide ad-hoc, upon receiving a respective notification from the server, the way of handling a non-deliverable incoming call which was forwarded to the server. Module 124 also enables the initiating user to decide ad-hoc the way of handling the non-deliverable call. In some embodiments, module 124 may be implemented in IN system 130 instead of server 106.

Management module 124 may exemplarily be an Interactive Voice Response (IVR) module, which is well known in voice mail systems. This module can be implemented over the same hardware as the IVM server, but will require a software implementation. When a call is delivered to an NR module by the telephony system (e.g. by an IN server), the IVR module can perform various functions based on an interaction with a user. Exemplarily, the user can be prompted to key in various dual-tone multi-frequency. (DTMF) signals and, according to his/her choices, the system will perform an activity. Further exemplarily, the module prompts the user to save a message by pressing the key “1” to call the sender by pressing the key “2”, to replay the message again by pressing the key “3”, etc. Inventively, the present invention uses this known module to enable the users to set up ad-hoc rules for call completion.

In general, system 100 is similar to the one disclosed in FIG. 1 of U.S. Patent Application No. 2006/0268750, except for the added IN system 130 and the added module 124. The telephony system may be either a conventional wire-line, cellular, VoIP or another IP network. Switch 104 may be a conventional telephony switch, a VoIP switch or an IP connectivity network with routing devices, and may include an optional conventional voice mail system 120. Furthermore, the telephony network may also include an SMS server system 122 that enables SMS communication, or other optional servers. These may include instant messengers such as ICQ or Microsoft Messenger, MMS—enabling multi media messaging, or PTT—enabling PTT messaging.

In use, an initiating user device 102 tries to call a target user device 110. Assume the call is non-deliverable for any one of the non-delivery reasons cited above. In this case, telephony system 108 will forward the call to server 106. Server 106 then offers the initiating user a conversion option, in which the call is converted into a converted entity, which will then be pushed to the target user. The converted entity may include a parked call, a parked instant message, voice mail, an instant voice message, or another type of message (MMS, PTT, ICQ, etc).

The server may check the status of the target user (i.e. when he/she become available) continuously or intermittently. The status check may be done in a number of ways, as described exemplarily in U.S. Patent Application No. 2006/0268750, or through the IN system. Server 106 may send an SMS message (e.g. without any content) with a delivery request from the telephony system (or more particularly the SMSC within the telephony network). If the target user is available or turned on, an SMS delivery acknowledgement will be delivered to server 106. Alternatively yet, the check may be done by sending an SMS type 0 message, or by checking the target user's dial tone.

It is also possible that the target user has forwarded all his/her incoming calls to server 106. This may happen for example if the target user has little time and wants to get only short voice messages. In such a case, all incoming phone calls will be forwarded by the telephony network to server 106. The server will notify the initiating user that the target user can receive only instant voice messages instead of phone calls. Therefore, the initiating user is requested to record his/her message, and this message will be instantly pushed to the target user.

### Exemplary Processes

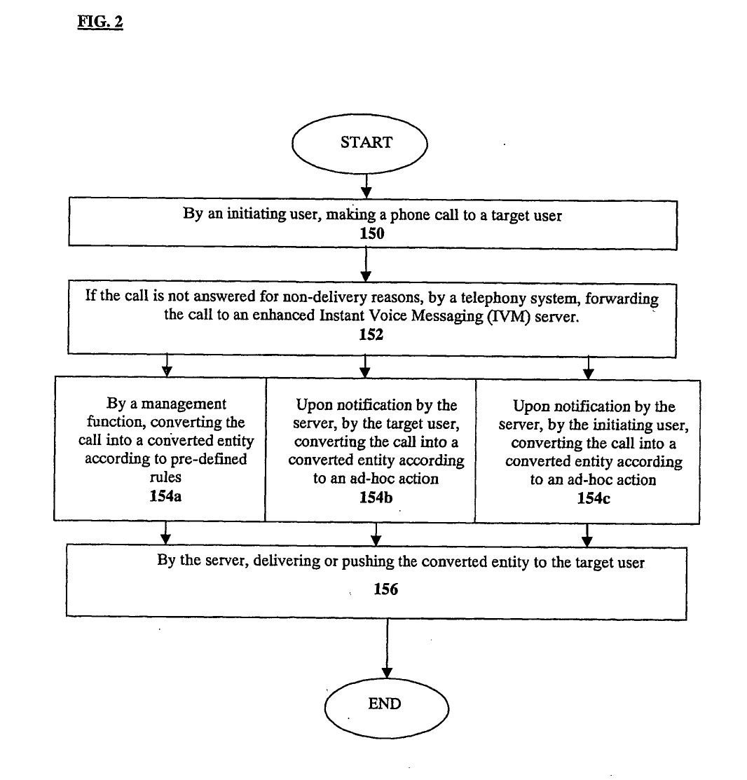

FIG. 2 shows a general flow chart of the major steps in the method for conversion of a phone call into a smart “push” of voice messages according to the present invention. The initiating user makes a phone call to a target user in step 150 Assume that the call cannot be delivered to the target user for a non-delivery reason. As a result, the non-delivered call is forwarded to enhanced IVM server 106 in step 152 by, for example, the IN 130 system. In a following step, there are now three possibilities: a) by management function 124, taking a course of action according to pre-defined rules in step 154a; b) upon notification by server 106, by the target user, taking an ad-hoc action in step 154b, and c) upon notification by server 106, by the initiating user, taking an ad-hoc action in step 154c. The action may include converting the call into a converted entity that, as mentioned above, may be a parked call, a parked instant voice message, voice mail, an instant voice message, or another type of message (MMS, PTT, ICQ, etc). Each non-delivery reason may have its own pre-determined rule for a particular action.

After the conversion, the converted entity (except for voice mail) is delivered (or pushed) to the target user in a delivery step 156 according to the following rules:

If the converted entity is a parked call or a parked instant voice message, it will be pushed when the respective non-delivery reason is removed.

If the converted entity is an instant voice message and if the non-delivery reason is call waiting, the IVM will be pushed during the call waiting period. If the non-delivery reason is “no reply”, the IVM will be pushed immediately.

If the converted entity is a voice mail, it will be delivered as a regular voice mail.

If the converted entity is another type of message it will be delivered or pushed according to a respective rules for that type of message delivery

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. In a voice communications network, a method for ensuring that a phone call from an initiating user reaches a target user, comprising the steps of:
a. by the initiating user, placing a phone call to the target user;
b. if the phone call is non-real-time-deliverable because of a non-delivery reason, forwarding the phone call to an instant voice messaging (IVM) server;
c. at the IVM server, converting the phone call into a converted entity; and
d. by the IVM server, delivering or pushing the converted entity to the target user.

2. The method of claim 1, wherein the step of converting includes converting the phone call into a converted entity selected from the group consisting of a parked call, a parked instant message, voice mail, an instant voice message and another type of message.

3. The method of claim 2, wherein, if the converted entity is a parked call or a parked instant voice message, the step of delivering includes pushing the parked call or parked instant voice message when the respective non-delivery reason is removed.

4. The method of claim 2, wherein, if the converted entity is an instant voice message and if the non-delivery reason is call waiting, the step of delivering includes pushing the instant voice message during the call waiting period.

5. The method of claim 2, wherein, if the converted entity is an instant voice message and if the non-delivery reason is no reply, the step of delivering includes pushing the instant voice message immediately.

6. The method of claim 2, wherein, if the converted entity is a voice mail, the step of delivering includes delivering the voice mail as a regular voice mail.

7. The method of claim 2, wherein, if the converted entity is another type of message, the step of delivering includes delivering the message according to respective rules.

8. The method of claim 1, wherein the step of delivering is preceded by a step of checking a status of the target user to ensure deliverability of the converted entity.

9. The method of claim 8, wherein the status check is performed by the IVM server.

10. The method of claim 8, wherein the status check is performed by an intelligent network system coupled to the IVM server.

11. The method of claim 2, wherein the converting the phone call into another type of message includes converting the phone call into a message selected from the group consisting of a multi media message, a push-to-talk message and an ICQ message.

12. In a communications network, a system for ensuring that a phone call from an initiating user reaches a target user comprising:
a. an instant voice messaging (IVM) server operative to receive a non-real-time deliverable phone call;
b. a management function operative to convert the received call into a converted entity and to deliver the converted entity to the target, and
c. a switch coupled to the IVM server and operative to effect communications between the initiating user, the target user and the IVM server.

13. The system of claim 12, wherein the management function is included in the IVM server.

14. The system of claim 12, wherein the converted entity is selected from the group consisting of a parked call, a parked instant message, voice mail, an instant voice message, a multi media message, a push-to-talk message and an ICQ message.

15. The system of claim 12, further comprising:
d. an intelligent network (IN) system for forwarding the non-real-time-deliverable call to the IVM server.

16. The system of claim 15, wherein the management function is included in the IN system.

17. In a voice communications network, a method for ensuring that a phone call from an initiating user reaches a target user, comprising the steps of:
a. by the initiating user, placing a phone call to the target user;
b. if the call is not answered for non-delivery reasons, by a telephony system included in the communication system, forwarding the call to an enhanced instant voice messaging (IVM) server;
c. at the IVM server, converting the phone call into a converted entity according to a rule selected from the group consisting of a pre-defined rule and an ad-hoc rule; and
d. by the IVM server, delivering or pushing the converted entity to the target user.

18. The method of claim 17, wherein the step of converting the phone call according to a pre-defined rule is performed by a management function included in the server.

19. The method of claim 17, wherein the step of converting the phone call according to an ad-hoc rule is performed by the initiating user.

20. The method of claim 17, wherein the step of converting the phone call according to an ad-hoc rule is performed by the target user.
